(19) United States
(12) Patent Application Publication
(10) Pub. No.: US 2006/0112805 A1
(43) Pub. Date: Jun. 1, 2006

(54) Drive unit for a granulator

(75) Inventors: Gregor Chszaniecki, Hannover (DE); Matthias Kroll, Wetzlar (DE)

Correspondence Address: CROWELL & MORING LLP;INTELLECTUAL PROPERTY GROUP, P.O. BOX 14300, WASHINGTON, DC, 20044-4300, US

(73) Assignee: Berstorff GmbH, Hannover (DE)

(21) Appl. No.: 11/246,147

(22) Filed: Oct. 11, 2005

Related U.S. Application Data
(63) Continuation of application No. PCT/EP04/03334, filed on Mar. 30, 2004.

(30) Foreign Application Priority Data
Apr. 9, 2003 (DE) 103 16 142.2

(51) Int. Cl. B26D 7/26

(52) U.S. Cl. 83/698.21

(57) ABSTRACT

A drive unit for a granulator, in particular an underwater granulator, includes a rotor that is, or can be, connected to a cutting blade of the granulator. The unit is equipped with an electric motor for driving the rotor and radial bearings for supporting the rotor in a housing, in addition to a device for applying an axial force, which presses the cutting blade against a cutting plate during operation. An axial force is applied in as simple a manner as possible with the least possible wear and tear by using a device for applying an axial force that includes at least one magnetic axial bearing, having a first axial bearing part, which is fixed in the housing of the drive unit, and co-operates with an axial bearing part that is displaceably, mounted in the rotor.

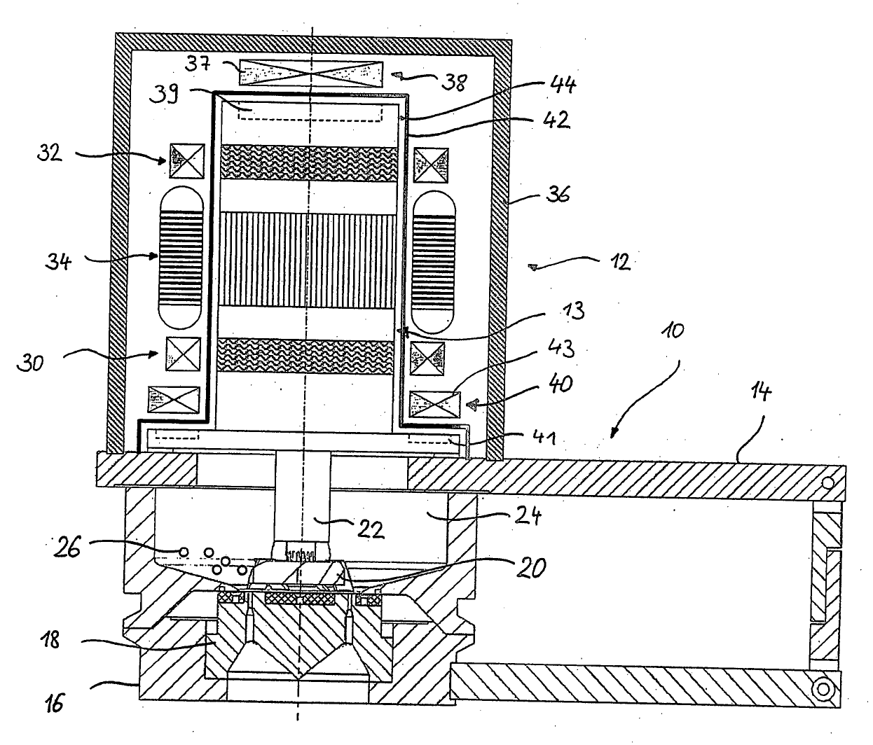

### CROSS-REFERENCE TO RELATED APPLICATIONS

This application is a continuation of PCT Application No. PCT/EP2004/003334 filed on Mar. 30, 2004 which claims priority to German Application 103 16 142.2 filed Apr. 9, 2003.

### BACKGROUND AND SUMMARY OF THE INVENTION

The invention relates to a drive unit for a granulator, in particular an underwater granulator, including a rotor which is connected or can be connected with a cutting blade of the granulator, an electric motor for driving the rotor, and radial bearings for supporting the rotor in a housing, as well as a device for applying an axial force in order to press the cutting blade against a cutting plate during operation. The invention further relates to a granulator having the aforementioned drive unit.

In the case of a granulator, plastic starting material that is melted in an extruder is, as a rule, fed to a cutting plate having nozzle bores arranged, for example, in a ring shape. On the side situated opposite the extruder, a blade head rotates on this cutting plate and cuts the exiting plastic strands. In the case of an underwater granulator, cooling water flows through the processing space, by which cooling water the produced granulated bodies are also removed. In the case of an underwater granulator, the cooling water is fed to the cutting chamber through a pipe.

Reference is made to German Patent documents DE 101 51 434 A, DE 199 14 116 A and DE 42 14 481 A as a description of the general state of the art.

During operation of a granulator, it is necessary for a defined axial force to be exercised on the cutting blade, by which the cutting blade is pressed against the cutting plate. If this axial force falls below a defined value, the plastic strands are no longer cut in a desired manner, but rather may be squeezed through between the cutting plate and the cutting blade. In contrast, if the axial force is selected to be too high, an excessive wear of the blade has to be accepted, which results in extended machine down-times and significantly increased costs.

In the case of previous granulators, it is also known to change the axial contact pressure force of the blades during operation of the granulator, for example, in order to reduce the wear of the blade after a steady-state operating condition has been reached. The blades can also be resharpened at defined time intervals by a targeted increase of the axial force.

On the whole, attempts have been made to reduce the machine down-time in the case of granulators and to decrease the blade wear and increase the tool life of the blades.

Pneumatic and hydraulic adjusting systems are known as solutions for adjustable axial forces. Such systems act upon the blade shafts and prestress these, for example, by hollow-shaft motors in the direction of the cutting plate. Depending on the construction, movable bearing units are required for this purpose, which bearing units have to be coupled to a drive in an axially flexible manner. However, these known solutions have the disadvantage that additional machine units, such as air compressor units or hydraulic-pressure generating units, are necessary. Mechanical solutions with adjustable spring forces are usually highly complex. Furthermore, the contact pressure force of the blades changes along the wear path corresponding to a respective characteristic spring curve.

It is therefore an object of the present invention to provide a drive unit and a granulator by which, or in the case of which, the above-mentioned disadvantages are eliminated.

This solution is achieved by providing a drive unit for a granulator, in particular an underwater granulator, including a rotor which is connected or can be connected with a cutting blade of the granulator, an electric motor for driving the rotor, and radial bearings for supporting the rotor in a housing, as well as a device for applying an axial force in order to press the cutting blade against a cutting plate during operation. The device for applying the axial force comprises at least one magnetic axial bearing, a first axial bearing part of which is fixedly arranged in the housing of the drive unit, and interacts with a movable axial bearing part which is arranged in the rotor. The solution is further achieved by a granulator having a correspondingly constructed drive unit according to the invention.

Accordingly, one aspect of the invention is that the desired axial force for pressing a cutting blade against a cutting plate is achieved by use of a magnetic axial bearing. This axial bearing includes a first axial bearing part, which is fixedly arranged in a housing of the drive unit, and a movable axial bearing part, which is arranged in the rotor. Naturally, two or more axial bearings may also be provided. One advantage of the magnetic axial bearing is the non-contact method of operation, which therefore causes no wear, and the method of construction, which is relatively simple compared with mechanical solutions.

A particularly preferred embodiment of the drive unit is characterized in that the radial bearings of the rotor are also constructed as non-contact magnetic bearings. In this case, the rotor runs absolutely without any contact and thus with little wear. This increases the operating reliability and reduces wear phenomena.

The use of magnetic radial bearings is known from the application field of centrifugal pumps or magnetically borne gap tube pumps. Analogously to the magnetically borne gap tube pumps, the rotor can be received in a so-called gap tube, and can be sealed off by means of the latter with respect to the housing. In the case of the gap tube, a defined circumferential gap, which surrounds the rotor, exists—during the operation—between the rotor and the gap tube itself. When the drive unit is switched off and the corresponding magnet arrangements become ineffective, the rotor is then held in the gap tube. Moreover, a liquid may be arranged in the gap tube, which liquid acts as a stabilizing, buffering and compensating medium.

According to another, particularly preferred embodiment of the drive unit, a control is provided and constructed such that the axial force may be adjusted or controlled in a desirable manner. In particular, the control may be constructed for maintaining the axial force—at least for defined time periods—constant at a defined value. In addition, the control may be constructed for varying the axial force during the operation; thus, for example, to increase the axial force at predefined intervals and, as a result, cause a regrinding of the blades.

For regulating purposes, it is contemplated to provide one or more sensors which detect, for example, the axial force or the position of the blade, and convert it to a corresponding signal.

Because of the possible wear of the cutting blade, a certain axial freedom of movement of the rotor arrangement must exist. This axial displacement may be in the range from 1 to 8 mm, particularly from 3 to 6 mm. It may naturally also be provided that the cutting blade is slightly set back before or after the operation of the granulator. In this case, it would be required to provide the axial displacement at an even greater range.

Other objects, advantages and novel features of the present invention will become apparent from the following detailed description of the invention when considered in conjunction with the accompanying drawings.

### BRIEF DESCRIPTION OF THE DRAWING

The single FIGURE is schematic diagram showing an underwater granulator together with a corresponding drive unit.

### DETAILED DESCRIPTION OF THE DRAWING

The schematic sectional view shows a part of the underwater granulator system. The extruder is not shown in its entirety; rather, only its output side end (reference number 16) is illustrated. The extruder is adjoined by a cutting plate 18, in which ducts ensure in a known manner a passage from the cylinder interior of the extruder out of the cutting plate. A blade head 20 of at least one cutting blade rests on the cutting plate, which cutting blade during rotation continuously cuts off the plastic strands exiting from the ducts of the cutting plate. In the cutting space 24, these plastic strands then form the only schematically shown granules 26.

In the case of an underwater granulator, cooling water, which is also used as a transport medium, is fed into the cutting space 24. The pipes required for this purpose are not shown in detail. By means of the cooling water, the granules, as well as the cutting device, are cooled, and the granules are then removed from the cutting space 24. The blade head 20 is arranged on a blade shaft 22, which leads into a rotor 13. The rotor is a central component of the drive unit 12, which is accommodated in a housing 36.

The housing 36 is arranged on a carrier frame 14 and is held by the latter. In the present embodiment (not shown), the carrier frame may be partially swiveled away, whereby the drive unit 12, together with the cutting blade, may be moved away from the cutting plate 18, in particular, can be folded away.

The drive unit 12 includes an electric motor 34 with a stator fixedly arranged in the housing and an electric motor rotor integrated in the rotor. In the present embodiment, the electric motor 34 is arranged essentially centrally within the drive unit. Two radial bearings 30 and 32, constructed as non-contact magnetic bearings, are arranged in the axial direction of the rotor 13 on both sides of the electric motor. Each radial bearing comprises an electromagnetically active, ring-shaped radial bearing part fixedly arranged in the housing and a rotor radial bearing part interacting with the housing-side radial bearing part and integrated in the rotor 13. The technique of a non-contact magnetic bearing has been used in the case of gap tube pumps to which reference is made in this respect.

In addition to the electric motor 34, and the two bearings 30 and 32 constructed as magnetic radial bearings, two axial bearings 40 and 38 are provided, which operate without any contact. The axial bearing 40 comprises a ring-shaped electromagnetically acting first bearing part, which interacts with a bearing element spaced away in the axial direction and integrated in the rotor 13 such that an axial force may be applied on the rotor 13 in the direction of the cutting plate 18.

The axial bearing 38 acts in the same manner. Here, an electromagnetically effective disk-shaped first bearing part 37 is fixedly accommodated in the housing, which interacts with the second bearing part 39 accommodated in the rotor 13. The axial bearing 38 is also used for the application of an axial force upon the rotor 13 in the direction of the cutting blade 18. By means of a corresponding electric actuation of the two bearing elements 43 and 37, the force can be adjusted differently in the axial direction.

In the present embodiment, the rotor 13 is arranged in a gap tube 42, which essentially has the same shape as the rotor, surrounds the latter, and is also fastened to the carrier frame 14.

Because of the essentially identical shaping of the rotor 13 and the gap tube 42, an essentially defined gap forms during the operation of the drive between the rotor 13 and the gap tube 42, which gap is also visible in the drawing. In this space, a liquid for damping an unsteady running may also be provided.

In the present case, the entire arrangement is constructed such that an axial displacement of the rotor 13 together with the blade shaft 22 and the blade head 20 may take place by approximately 4-6 mm.

In addition, in the case of the present invention (not shown in the drawing), a control unit is provided, which is connected with the electric motor and the axial bearings 40 and 38 and controls or regulates their operation. The control device may receive information, for example, about the contact pressure force of the blade head 20 onto the cutting plate 18, or about the axial position of the rotor, from sensors, which are also not shown, and can carry out a control by use of such information.

The method of operation of the present embodiment will be explained in detail in the following.

Before the operation of the present underwater granulator, the drive unit 12 may possibly be folded away. For the operation, the drive unit together with the cutting blade 22, is folded shut and locked. As a result, the cutting blade head 20 comes to rest loosely against the cutting plate 18.

When the underwater granulator is started, on the one hand, the operation of the extruder, which is not shown in detail, is started. Plastic material is melted in the extruder and is pressed out through the ducts arranged in the cutting plate 18.

The drive unit 12 is operated in a parallel manner. In this case, the radial bearings 30 and 32 are activated and the electric motor 34 is started. By means of the rotation of the rotor 13, which first rests in the gap tube 12 against the latter at one point, the rotor is caused to carry out a rotating movement and, during the rotating movement, is essentially centered and held and disposed in a non-contact manner by the radial bearings 30 and 32. Simultaneously, the axial bearings 38 and 40 are activated, whereby the rotor 13 is acted upon in the axial direction downward in the figure, so that the blade head 20 of the cutting blades comes into a force contact on the cutting plate 18. With the rotating cutting blade, the plastic strands exiting from the ducts of the cutting plate 18 are cut into a granulate shape.

During the start of the operation of the drive unit, an increased axial force is first selected in order to achieve a proper cutting-off of the first exiting plastic strand regions. In the course of the operation, the axial force is then reduced to a normal operation with a lower contact pressure force which is sufficient for the proper cutting-off of the plastic strands.

Irrespective of a possible wear of the blades of the blade head 20, the axial force can be kept constant by a corresponding action upon the axial bearings 38 and 40. At certain time intervals, the axial force is increased to a predefined value in order to resharpen the blades of the blade head 20. In this case, the axial force should be adjustable at least in a range which generates surface pressures between 0 and 1 N/mm² on the cutting surfaces. Higher maximal forces are also often desirable. The play of the blade shaft, which is radially disposed by way of the rotor at two points by use of the magnetic bearings, corresponds essentially to the play of customary roller bearings.

On the whole, by use of the present embodiment of the drive unit and of the granulator, an arrangement is achieved which—with the exception of the cutting blade arrangement—operates without wear. In addition, the axial force may, in each case, be varied and adjusted in a desirable manner without requiring complicated mechanical devices.

### TABLE OF REFERENCE NUMBERS

10 underwater granulator
12 drive unit
13 rotor
14 carrier frame
16 extruder output
18 cutting plate
20 blade head
22 blade shaft
24 cutting space
26 granules
30 forward magnetic radial bearing
32 rearward magnetic radial bearing
34 electric motor
36 housing for drive unit
37 fixed axial bearing part
38 rearward magnetic axial bearing
39 magnetic disk
40 forward magnetic axial bearing
41 magnetic ring
42 gap tube
43 fixed axial bearing part
44 gap

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A drive unit for a granulator having a cutting blade, the drive unit comprising:
a housing;
a rotor arranged in the housing and coupleable with the cutting blade of the granulator;
an electric motor for driving the rotor;
radial bearings provided in the housing for supporting the rotor;
a device for applying an axial force in order to press the cutting blade against a cutting plate when in operation, the device including at least one magnetic axial bearing, a first axial bearing part of which is fixedly arranged in the housing and interacts with a moveable axial bearing part which is arranged in the rotor; and
a gap tube which accommodates the rotor and seals the rotor off with respect to the housing.

2. The drive unit according to claim 1, wherein at least two magnetic axial bearings are arranged in an axially mutually offset manner in an area of the rotor.

3. The drive unit according to claim 1, wherein the radial bearings are configured as non-contact magnetic bearings having a first radial bearing part fixedly arranged in the housing and a moveable radial bearing part arranged in the rotor.

4. The drive unit according to claim 2, wherein the radial bearings are configured as non-contact magnetic bearings having a first radial bearing part fixedly arranged in the housing and a moveable radial bearing part arranged in the rotor.

5. The drive unit according to claim 1, wherein, when viewed in an axial direction, the electric motor is arranged between two magnetic radial bearings, and further wherein the two magnetic radial bearings are arranged between two magnetic axial bearings.

6. The drive unit according to claim 1, wherein a liquid is provided in a space formed between the gap tube and the rotor.

7. The drive unit according to claim 1, further comprising one of an electric control and closed-loop control operatively configured for adjusting or regulating the axial force in a controlled manner.

8. The drive unit according to claim 7, wherein said control is operatively configured for maintaining the axial force at a constant value at least for defined time periods.

9. The drive unit according to claim 7, wherein the control is operatively configured for varying the axial force during operation of the drive unit.

10. The drive unit according to claim 8, wherein the control is operatively configured for varying the axial force during operation of the drive unit.

11. The drive unit according to claim 9, wherein the control includes an interval control for increasing the axial force at pre-selected time intervals.

12. The drive unit according to claim 1, further comprising at least one sensor which detects the axial force or a position of a blade shaft of the granulator and converts the force or position to a corresponding signal.

13. The drive unit according to claim 1, wherein the electric motor, the radial bearings, and the at least one magnetic axial bearing are operatively configured to permit an axial displacement of the cutting blade in a defined length range.

14. The drive unit according to claim 13, wherein the axial displacement is in a range of from 1 to 8 mm.

15. The drive unit according to claim 14, wherein the range is from 3 to 6 mm.

16. The drive unit according to claim 1, wherein the drive unit is used with an underwater granulator.

17. A granulator, comprising:
an extruder;
a cutting plate arranged at an output of the extruder;
a cutting blade operatively arranged with respect to the cutting plate; and
a drive unit, the drive unit comprising:
a rotor arranged in the housing and coupleable with the cutting blade of the granulator;
an electric motor for driving the rotor;
radial bearings provided in the housing for supporting the rotor;
a device for applying an axial force in order to press the cutting blade against a cutting plate when in operation, the device including at least one magnetic axial bearing, a first axial bearing part of which is fixedly arranged in the housing and interacts with a moveable axial bearing part which is arranged in the rotor; and
a gap tube which accommodates the rotor and seals the rotor off with respect to the housing.
